(19) United States
(12) Patent Application Publication
(10) Pub. No.: US 2013/0239565 A1
(43) Pub. Date: Sep. 19, 2013

(54) SPATIALLY GRADED SMA ACTUATORS

(71) Applicants: Alan L. Browne, Grosse Pointe, MI (US); Nancy L. Johnson, Northville, MI (US)

(72) Inventors: Alan L. Browne, Grosse Pointe, MI (US); Nancy L. Johnson, Northville, MI (US)

(73) Assignee: GM GLOBAL TECHNOLOGY OPERATIONS LLC, Detroit, MI (US)

(21) Appl. No.: 13/422,959

(22) Filed: Mar. 16, 2012

(51) Int. Cl. F03G 7/06; C22C 38/00

(52) U.S. Cl. 60/527; 148/402

(57) ABSTRACT

A shape memory alloy element is disclosed that is configured to undergo a graded thermal change along a dimension of the shape memory alloy element in response to thermal stimulus. This graded thermal change produces a change between the Martensitic and Austenitic states of the shape memory alloy that is graded along this dimension, which in turn produces a graded displacement response of the shape memory element.

### FIELD OF THE INVENTION

Exemplary embodiments of the invention are related to metallic shape memory alloy (“SMA”) actuators and, more specifically, to SMA actuators having unique thermal response characteristics.

### BACKGROUND

Shape memory alloys are well-known in the art. Shape memory alloys are alloy compositions with at least two different temperature-dependent phases. The most commonly utilized of these phases are the so-called Martensite and Austenite phases. In the following discussion, the Martensite phase generally refers to the more deformable, lower temperature phase whereas the Austenite phase generally refers to the more rigid, higher temperature phase. When the shape memory alloy is in the Martensite phase and is heated, it begins to change into the Austenite phase. The temperature at which this phenomenon starts is often referred to as the Austenite start temperature (Aₛ). The temperature at which this phenomenon is complete is called the Austenite finish temperature (A_{f}). When the shape memory alloy is in the Austenite phase and is cooled, it begins to change into the Martensite phase, and the temperature at which this phenomenon starts is referred to as the Martensite start temperature (Mₛ). The temperature at which Austenite finishes transforming to Martensite is called the Martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is typically at or below the Austenite transition temperature (at or below Aₛ). Subsequent heating above the Austenite transition temperature causes the deformed shape memory alloy sample to revert back to its permanent shape. Thus, a suitable activation signal for use with shape memory alloys is a thermal activation signal having a magnitude that is sufficient to cause transformations between the Martensite and Austenite phases.

Due to their temperature-dependent shape memory properties, shape memory alloys are used or have been proposed for use as actuators or other elements requiring controlled movement in various mechanical and electromechanical devices or other applications such as air flow control louvers, reversibly deployable grab handles, portable insulin pumps, and computer media eject mechanisms, to name a few. One commonly-used configuration is that of an SMA wire with two ‘remembered’ lengths, where the wire is attached to an element or device component that is moved between different positions by transforming the wire between longer and shorter remembered lengths. Other configurations can be utilized as well, such as an SMA actuator that can be transformed between a straight and bent shape. The thermal stimulus to transform an SMA actuator between different states can be a direct external thermal stimulus, such as heat applied from a heat source like an infrared, convective, or conductive heating element. However, in the case of an SMA wire actuator, the thermal stimulus is often applied by simply running electrical current through the wire to cause it to heat up, and terminating the current so that the wire cools down by transferring heat to the surrounding cooler environment.

The temperature at which the shape memory alloy remembers its high temperature form when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, typically providing shape memory effect, superelastic effect, and high damping capacity. For example, in the Martensite phase a lower elastic modulus than in the Austenite phase is observed. Shape memory alloys in the Martensite phase can undergo large deformations by realigning the crystal structure arrangement with the applied stress, e.g., pressure from a matching pressure foot. The material will retain this shape after the stress is removed.

The transition of a shape memory alloy between Martensitic and Austenitic states as a function of temperature is depicted in the plot of FIG. 1 where vertical axis ξ represents the fraction of the composition in the Martensite state and the horizontal axis T represents the temperature. The upper curve shown in FIG. 1 with the accompanying arrow pointing downward and to the right depicts the transition from the Martensitic state to the Austenitic state caused by an increase in temperature, with the Aₛ and A_{f} temperatures denoted on the horizontal axis. The lower curve in FIG. 1 with the accompanying arrow pointing upward and to the left depicts the transition from the Austenitic state to the Martensitic state caused by a decrease in temperature, with the Mₛ and M_{f} temperatures denoted on the horizontal axis.

For many shape memory alloys, the change between the Martensitic state and the Austenitic state and vice versa in response to thermal stimulus can occur relatively quickly. This may be due to various factors such as the composition having a narrow temperature range between the Aₛ and A_{f} temperatures and/or between the Mₛ and M_{f} temperatures. Other factors include the electrical characteristics of the shape memory alloy being such that the temperature of an SMA wire heats quickly through the Aₛ to A_{f} temperature range when current is applied. This can lead to a relatively rapid change between remembered shapes or lengths of an SMA actuator, which is undesirable in many circumstances where a slower actuation is desired for aesthetic and/or functional reasons.

Accordingly, it is desirable to provide a shape memory alloy element where the response can be tailored to meet target actuation rates in response to a thermal stimulus.

### SUMMARY OF THE INVENTION

In an exemplary embodiment of the invention, a shape memory alloy element is configured to undergo a graded thermal change along a dimension of the shape memory alloy element in response to thermal stimulus. This graded thermal change produces a change between the Martensitic and Austenitic states of the shape memory alloy that is graded along this dimension, which in turn produces a graded displacement response of the shape memory element.

In an exemplary embodiment of the invention, the graded thermal response of the SMA element is produced by a gradation, along a dimension of the element, in the ratio of surface perimeter to cross-sectional area in a plane perpendicular to that dimension. In another exemplary embodiment, the graded thermal response of the SMA element is produced by a gradation, along a dimension of the element, in cross-sectional geometrical configuration in a plane perpendicular to that dimension. In yet another exemplary embodiment, SMA element has a coating thereon, and the graded thermal response is produced by a gradation, along a dimension of the SMA element, in cross-sectional geometrical configuration in a plane perpendicular to that dimension, or in thickness.

In yet another exemplary embodiment, an actuator includes a shape memory alloy element that is configured to undergo a graded thermal change along a dimension of the shape memory alloy element in response to thermal stimulus. This graded thermal change produces a change between the Martensitic and Austenitic states of the shape memory alloy that is graded along this dimension, which in turn produces a graded displacement response along the dimension of the shape memory element. In exemplary embodiments, the graded thermal response is provided by gradations, along that dimension, in the configuration of the SMA element or in a coating on the SMA element, as described above. In another embodiment, the graded thermal response of the SMA element is provided by a gradation, along a dimension of the SMA element, in the cross-sectional geometry or thickness of a portion of the actuator in thermal communication with the SMA element. In yet another exemplary embodiment, the graded thermal response is provided by a gradation, along a dimension of the SMA element in convection to which the SMA element is subjected.

The above features, and advantages thereby provided, along with other features and advantages are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a plot of phase change versus temperature of a typical shape memory alloy;

FIG. 2 depicts a longitudinal cross-section view of an embodiment where an SMA element has a continuous gradation in diameter;

FIG. 3 depicts a longitudinal cross-section view of an embodiment where an SMA element has a coating with a continuous gradation in thickness;

FIG. 4 depicts a longitudinal cross-section view of an embodiment where an SMA element has stepwise gradations in diameter;

FIG. 5 depicts a longitudinal cross-section view of an embodiment where an SMA element has a coating with stepwise gradations in thickness;

FIG. 6 depicts a longitudinal cross-section view of an embodiment where an SMA element has stepwise and continuous gradations in diameter;

FIG. 7 depicts a longitudinal cross-section view of an embodiment where an SMA element has a coating with stepwise and continuous gradations in thickness;

FIGS. 8A and 8B depict an embodiment where an SMA element has gradation in cross-sectional geometry;

FIGS. 9A and 9B depict an embodiment where an SMA element has a coating with a gradation in cross-sectional geometry;

FIG. 10 depicts a longitudinal cross-section view of an actuator where a portion of the actuator in thermal communication with an SMA element has a gradation in thickness; and

FIG. 11 depicts a perspective view of an actuator configured to provide an SMA element with a gradation in convection.

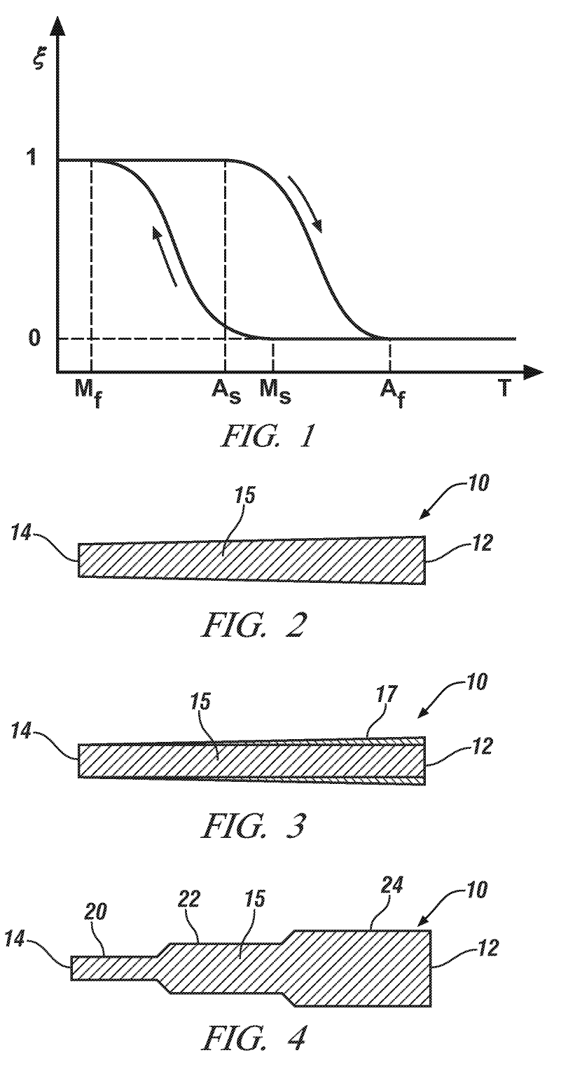

### DESCRIPTION OF THE EMBODIMENTS

In accordance with an exemplary embodiment of the invention, a shape memory alloy element is configured to undergo a graded thermal change along a dimension of the shape memory alloy element in response to thermal stimulus. By graded thermal change along a dimension of the SMA element, it is meant that at a point in time, the thermal energy level at one position along this dimension is different than the thermal energy level at a different position along the dimension. Since it is the addition or withdrawal of thermal energy from the shape memory alloy that induces the phase change back and forth between the Austenitic and Martensitic states, the ability to modify the timing of thermal change at different positions on the SMA element enables the modification of the timing of the phase change at different positions on the SMA element, thereby modifying the timing of the displacement response of the SMA element in response to thermal stimulus. SMA elements can be formed in a variety of configurations and, accordingly there is no particular limitation on the orientation of the dimension along which the SMA element exhibits a graded thermal change as long as it provides the desired displacement response of the SMA element. In an exemplary embodiment, the dimension is a linear dimension. In another exemplary embodiment, the SMA element is in the form of a shape memory alloy wire and the linear dimension is parallel to the longitudinal axis of the wire.

The graded thermal response along a dimension of the SMA element can be provided by a gradation, along that dimension, in the ability of the SMA element to absorb or dissipate heat. In one exemplary embodiment, the graded thermal response is provided by a gradation, along the dimension, in the ratio of surface perimeter to cross-sectional area in a plane that is perpendicular to that dimension. As the gradation is integrated along the dimension, the ratio of cross-sectional area to surface perimeter corresponds to a ratio of volume to surface area. At a given density, volume corresponds to mass, and thus to the quantity of thermal energy in the SMA element. At a given heat transfer coefficient for the SMA material, the surface area corresponds to the rate of heat transfer into or out of the SMA element through that surface. Thus a greater ratio of cross-sectional area to surface perimeter (area to perimeter ratio or “APR”) will indicate slower heat transfer between the SMA element and its surroundings while a higher ratio will indicate faster heat transfer. In the typical case of heat energy generated internally by application of electrical current to the SMA element, areas with a lower APR will dissipate that heat more readily than areas with a higher ratio. Not accounting for any effect of cross-sectional variations on the rate of electrical resistance heat generation, areas with a higher APR will heat up more readily in response to the application of electrical current and will cool down more slowly when the current is removed, compared to areas with a lower APR. In one exemplary embodiment, the graded thermal response can be utilized to provide a time-based gradation in the displacement response of the SMA element where higher APR portions of the element exhibit a faster response during heating to thermal stimulus and lower APR portions of the element exhibit a slower response during heating. The reverse holds for cooling after the current has been shut off. In another exemplary embodiment, the graded thermal response can be utilized to provide a controllable overall displacement in response to the application varying levels of electrical current. In this embodiment, a given current level generates an amount of heat sufficient to raise the temperature high enough in some (higher APR) portions of the element to induce a phase change from Martensite to Austenite, but not in some (lower APR) portions of the element. Progressively higher current levels will cause lower APR portions to reach temperature levels sufficient to induce a phase change, thereby producing greater overall levels of displacement in the element. In this fashion, controllable levels of actuation can be provided by varying the current.

In an exemplary embodiment, APR can be varied by varying thickness or diameter of an SMA element. Turning now to the figures, where the same numbers may be used to identify the same or like elements in different figures. FIG. 2 depicts a longitudinal cross-sectional view of an SMA element 10 in the form of a round SMA wire. In FIG. 2, SMA element 10 has right end 12 and left end 14, which may optionally be configured for attachment to external elements or components to be acted on by the SMA element. The element, which is formed from a shape memory alloy 15, has a continuous gradation in diameter, the diameter continuously changing from a smaller diameter at the left end 14 to a larger diameter at the right end 12. For a round wire, the cross-sectional area is equal to πr² and the surface perimeter is equal to 2πr, and thus the APR is πr²/2πr=r/2. Thus, the continuously varying diameter or radius of the SMA wire shown in FIG. 2 provides a continuously varying APR, and thus a varying thermal change along the axial dimension of the wire.

In addition to varying the thickness or diameter of the SMA element itself, APR can be varied with a coating on the SMA element 10 of varying thickness. FIG. 3 depicts a longitudinal cross-section view of an SMA element 10 comprising a round SMA wire formed from a shape memory alloy 15 having a coating 17 thereon. The coating 17 has a continuous gradation in thickness, from no coating at the left end 14 to a thick coating at the right end 12. The use of the coating 17 may provide additional parameters for tailoring the thermal response characteristics of the SMA element 10, as the coating 17 allows for thermal transfer properties to be varied with APR, while eliminating variance in electrical resistance heat generation caused by cross-sectional area of the SMA metal itself. The coating 17 can also have a different thermal conductivity and different heat capacity than the SMA material itself, providing further parameters for tailoring the thermal response of the SMA element 10. For example, the composition of the coating 17, and correspondingly its heat capacity and/or thermal conductivity, can be varied in a graded fashion along an axial dimension of the SMA element 10.

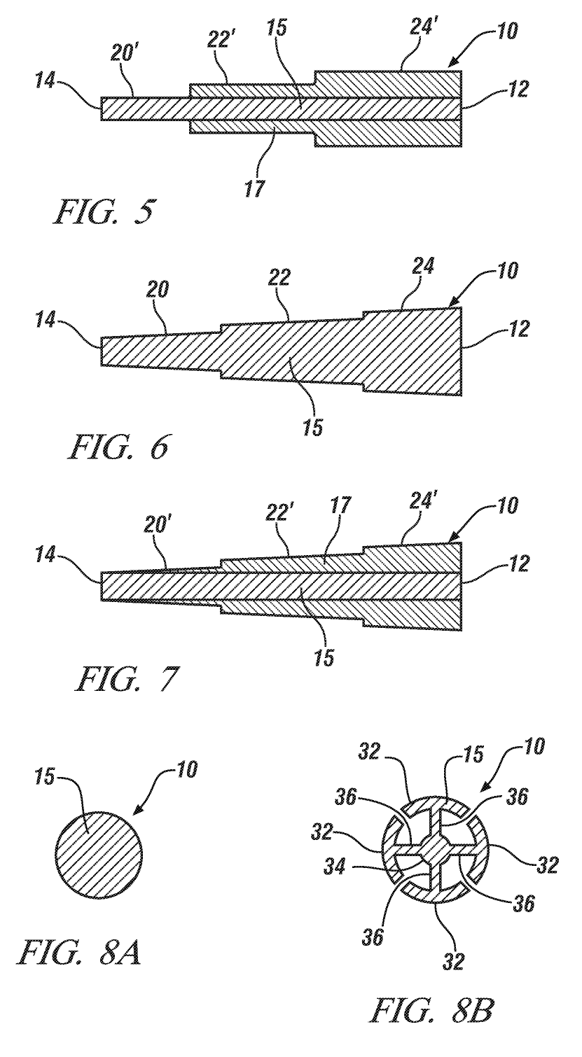

FIGS. 2 and 3 depict exemplary embodiments where SMA elements exhibit a continuous gradation in APR. In another exemplary embodiment, an SMA element can include a stepwise gradation in APR. FIGS. 4 and 5 depict exemplary embodiments of SMA elements with stepwise gradations. In FIG. 4, SMA element 10 having right end 12 and left end 14 is formed from shape memory alloy 15. The SMA element 10 has stepwise gradations in diameter between section 20 having a first diameter, section 22 having a diameter larger than the first diameter, and section 24 having a diameter larger than the diameter of section 22. In FIG. 5, an SMA element 10 having a constant diameter wire formed from shape memory alloy 15 has a coating 17 thereon. Coating 17 has stepwise gradations in diameter between section 20 having a first thickness, section 22 having a thickness larger than the first thickness, and section 24 having a thickness larger than the thickness of section 22. The stepwise gradations can be abrupt as shown for example in FIG. 6 or they can have a chamfered configuration as shown in FIG. 4. The chamfered configuration can help manage stress concentration in the SMA element 10, potentially avoiding formation of cracks that could lead to premature failure of the SMA element 10.

FIGS. 6 and 7 depict embodiments of SMA elements with both continuous and stepwise gradations. In FIG. 6, SMA element 10 having right end 12 and left end 14 is formed from shape memory alloy 15. The SMA element 10 has stepwise gradations in diameter between section 20 having a first diameter, section 22 having a diameter larger than the first diameter, and section 24 having a diameter larger than the diameter of section 22. Additionally, the diameter of the SMA element 10 undergoes a continuous gradation, becoming progressively larger moving from left end 14 toward right end 12, in each of the sections 20, 22, and 24. FIG. 7 depicts an SMA element 10 that includes a coating 17 having gradations thickness between section 20 having a first thickness, section 22 having a thickness larger than the first thickness, and section 24 having a thickness larger than the thickness of section 22. Additionally, the thickness of the SMA element 10 undergoes a continuous gradation, becoming progressively thicker moving from left end 14 toward right end 12, in each of the sections 20, 22, and 24.

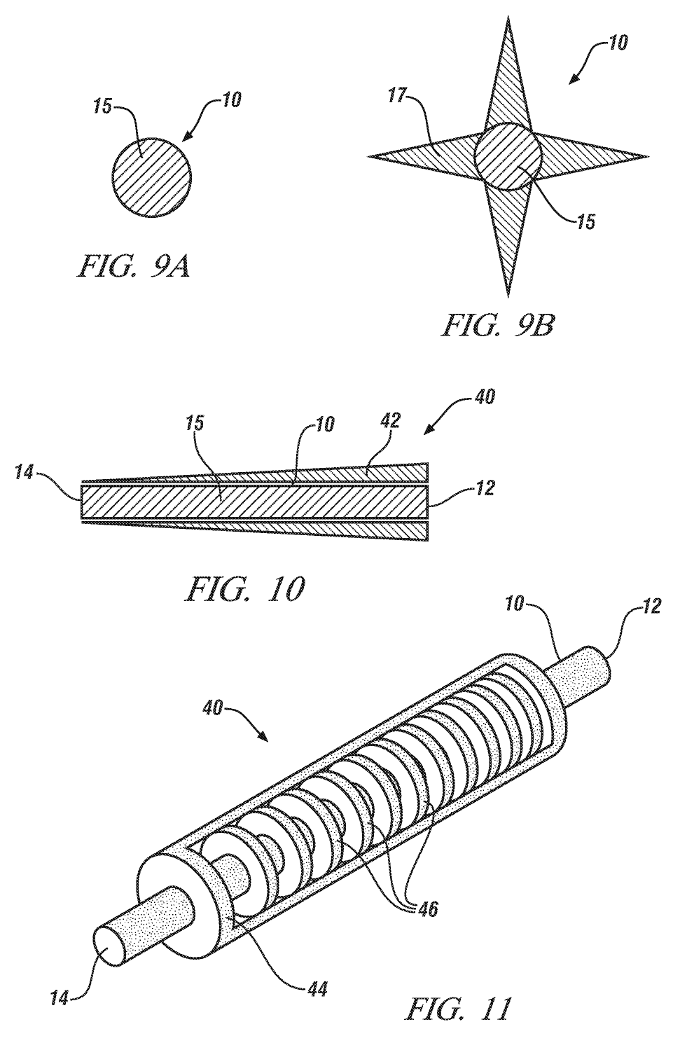

The embodiments in FIGS. 2-7 described above rely on a gradation in cross-sectional area to surface perimeter (“APR”) to provide a gradation of heat flow in and out of an SMA element, thereby producing a graded thermal change and concomitant graded displacement response of the SMA element. In another exemplary embodiment, a graded thermal change along a dimension of an SMA element can result from a gradation in cross-sectional geometry in a plane of the SMA element perpendicular to that dimension. The cross-sectional geometry of an SMA wire affects the pattern of conductive heat transfer within the SMA element, which in turn impacts the distribution of heat energy that causes the SMA phase transformation. Accordingly, a gradation in cross-sectional geometry produces a graded thermal change and concomitant graded displacement response of the SMA element. Although a gradation in cross-sectional geometry may often be accompanied by a gradation in APR, a gradation in cross-sectional geometry would impact heat flux and distribution of heat energy in the SMA element even if the cross-sectional gradation were implemented with configurations and overall thickness/diameter variations so as to hold APR constant. FIGS. 8 and 9 depict embodiments of SMA elements having a gradation in cross-sectional geometry as illustrated by radial cross-sectional views from different positions along the length of an SMA wire. FIGS. 8A and 8B depict a radial cross-section view of an SMA element 10 formed from shape memory alloy 15 where the SMA element 10 has a gradation between a round cross-sectional geometry as shown in FIG. 8A and a more complex cross-sectional geometry as shown in FIG. 8B. FIG. 8B depicts a complex cross-sectional geometry formed from shape memory alloy 15, having peripheral lobe portions 32 connected to circular cross-sectioned central portion 34 by legs 36. In such a configuration, the peripheral lobe portions 32 would transfer heat to and from the surrounding environment more rapidly than central portion 34, thereby providing a variation in heat flux (compared to the circular cross-sectioned geometry shown in FIG. 8A) in the SMA element 10 when it is either heating up or cooling down. FIGS. 9A and 9B depict a gradation in cross-sectional geometry provided by a coating 17, where the SMA element 10 has a gradation between a round cross-sectional geometry as shown in FIG. 9A and a more complex cross-sectional geometry as shown in FIG. 9B. FIG. 9B depicts an SMA element 10 formed from a shape memory alloy 15 having a coating 17 thereon in a star-shaped configuration.

As discussed above, SMA elements such as SMA wires may be used as actuators for a variety of devices simply by attaching the ends of the wire to components the actuator is intended to act upon and subjecting the wire to thermal stimulus. SMA elements can also be integrated with other components to form an actuator. For example, an SMA wire may be encased in a sleeve for protection or to maintain its position or shape in a particular configuration. Any of the above-described SMA elements can be integrated with other components to form an actuator. Additionally, in some exemplary embodiments described herein, a portion of the actuator in thermal communication with the SMA element includes a gradation, along a dimension of the SMA element, in cross-sectional geometrical configuration in a plane perpendicular to that dimension, or in thickness. Such embodiments are similar to the coating embodiments described above in FIGS. 3, 5, 7, and 9, except that the gradation is provided by a portion of the actuator in thermal communication with the SMA element instead of by a coating on the SMA element. An exemplary embodiment is illustrated in FIG. 10, where actuator 40 has an SMA element 10 such as an SMA wire having right end 12 and left end 14 formed from a shape memory alloy 15. The SMA element 10 is slidably disposed in a sleeve member 42. A tight tolerance between the outer diameter of the SMA element 10 and the inner diameter of the sleeve 42 promotes thermal communication between the SMA element 10 and the sleeve member 42. Sleeve member 42 is shown having a continuous gradation in thickness, from minimal thickness at the left end 14 to a greater thickness at the right end 12.

In another exemplary embodiment, a graded thermal change can be provided to an SMA element by varying the degree of convection to which the SMA element is subjected. This can be accomplished in various ways, such as by providing an actuator with a fan that directs a graded pattern of airflow over the SMA element, by providing an actuator sleeve or housing that has a graded pattern of openings, or both. Portions of the SMA element exposed to greater levels of convection will have a higher rate of heat transfer to or from the surrounding environment, thus creating a thermal gradation in the SMA element, thereby providing a graded displacement response. An exemplary embodiment is depicted in FIG. 11, in which SMA element 10 is slidably disposed in actuator housing 44. Actuator housing 44 is shown with grille members or fins 46 having a graded spacing therebetween so as to form a graded pattern of openings. Grille members or fins 46 are shown with wider spacing (thus allowing for greater convection) toward the left end 14 of the SMA element 10, and narrower spacing (thus allowing for less convection) toward the right end 12 of the SMA element 10.

Suitable shape memory alloy materials for fabricating the conformable shape memory article(s) described herein include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order. Selection of a suitable shape memory alloy composition depends on the temperature range where the component will operate. SMA elements typically must be worked or trained at different temperatures in order to remember different shapes between the Austenitic and Martensitic states. SMA elements may exhibit one-way or two-way shape memory depending on the application for which they are intended, and the embodiments disclosed herein may be used with either one-way or two-way SMA elements.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A shape memory alloy element configured to undergo a graded thermal change along a dimension of the shape memory alloy element in response to thermal stimulus, thereby providing a graded displacement response of the element.

2. The shape memory alloy element of claim 1, wherein the shape memory alloy element includes a gradation, along said dimension, in a ratio of surface perimeter to cross-sectional area in a plane perpendicular to said dimension, or in cross-sectional geometrical configuration in said plane.

3. The shape memory alloy element of claim 1, having a coating thereon, wherein the coating includes a gradation, along said dimension, in cross-sectional geometrical configuration in a plane perpendicular to said dimension, or in thickness.

4. The shape memory alloy element of claim 1, having a coating thereon, wherein the coating includes a gradation, along said dimension, in material composition of the coating, thereby providing a gradation along said dimension in thermal conductivity, in heat capacity, or in both thermal conductivity and heat capacity.

5. The shape memory alloy element of claim 1, wherein the graded thermal change that the shape memory alloy element is configured to undergo includes a step-wise thermal change along said dimension.

6. The shape memory alloy element of claim 2, wherein said gradation includes a stepwise gradation along said dimension, in the ratio of surface perimeter to cross-sectional area in the plane perpendicular to said dimension, or in cross-sectional geometrical configuration in said plane.

7. The shape memory alloy element of claim 3, wherein said coating includes a stepwise gradation, along said dimension, in cross-sectional geometrical configuration in the plane perpendicular to said dimension, or in thickness.

8. The shape memory alloy element of claim 4, wherein said coating includes a stepwise gradation, along said dimension, in material composition of the coating, thereby providing a stepwise gradation along said dimension in thermal conductivity, in heat capacity, or in both thermal conductivity and heat capacity.

9. The shape memory alloy element of claim 1, wherein the graded thermal change that the shape memory alloy element is configured to undergo includes a continuous thermal change along at least a segment of said dimension.

10. The shape memory alloy element of claim 2, wherein said gradation includes a continuous gradation along at least a segment of said dimension, in the ratio of surface perimeter to cross-sectional area in the plane perpendicular to said dimension, or in cross-sectional geometrical configuration in said plane.

11. The shape memory alloy element of claim 3, wherein said coating includes a continuous gradation, along at least a segment of said dimension, in cross-sectional geometrical configuration in the plane perpendicular to said dimension, or in thickness.

12. The shape memory alloy element of claim 4, wherein said coating includes a continuous gradation, along at least a segment of said dimension, in material composition of the coating, thereby providing a stepwise gradation along said dimension in thermal conductivity, in heat capacity, or in both thermal conductivity and heat capacity.

13. An actuator comprising a shape memory alloy element configured to undergo a graded thermal change along a dimension of the shape memory alloy element in response to thermal stimulus, thereby providing a graded displacement response of the element.

14. The actuator of claim 13, wherein the shape memory alloy element includes a gradation, along said dimension, in a ratio of surface perimeter to cross-sectional area in a plane perpendicular to said dimension, or in cross-sectional geometrical configuration in said plane.

15. The actuator of claim 13, having a coating thereon, wherein the coating includes a gradation, along said dimension, in cross-sectional geometrical configuration in the plane perpendicular to said dimension, or in thickness.

16. The actuator of claim 13, having a coating thereon, wherein the coating includes a gradation, along said dimension, in material composition of the coating, thereby providing a gradation along said dimension in thermal conductivity, in heat capacity, or in both thermal conductivity and heat capacity.

17. The actuator of claim 13, wherein the actuator is configured to provide a gradation, along said dimension, in forced convective heat transfer to which the shape memory alloy element is subjected.

18. The actuator of claim 13, wherein the actuator is configured to provide a gradation, along said dimension, in free convection to which the shape memory alloy element is subjected.

19. A method of operating the actuator of claim 13, comprising passing electrical current through the shape memory alloy element and controlling the current level to produce a phase change in a desired portion of the shape memory alloy element, thereby producing a desired displacement response in said actuator.

20. A method of operating the actuator of claim 13, comprising passing electrical current through the shape memory alloy element at a current level sufficient to produce a phase change occurring at different times in different portions of the shape memory alloy element, thereby producing a time-graded displacement response in said actuator.
